(19) United States
(12) Patent Application Publication
(10) Pub. No.: US 2010/0054082 A1
(43) Pub. Date: Mar. 4, 2010

(54) Reverse-time depth migration with reduced memory requirements

(75) Inventors: Raymond G. McGarry, Calgary (CA); Jeffrey A. Mahovsky, Calgary (CA); Peyman P. Moghaddam, Calgary (CA); Darren S. Foltinek, Calgary (CA); Daniel J. Eaton, Calgary (CA)

Correspondence Address: Gard and Kaslow LLP, One 1st Street, Suite 9, Los Altos, CA, 94022, US

(73) Assignee: Acceleware Corp.

(21) Appl. No.: 12/231,138

(22) Filed: Aug. 29, 2008

(51) Int. Cl. G01V 1/30

(52) U.S. Cl. 367/53

(57) ABSTRACT

A method of prestack reverse-time migration of seismic data that yields significant gains in computer storage and memory bandwidth efficiency is disclosed. The values only of the source wave incident on the boundaries of a simulation domain are saved, rather than all of the values of the wavefield throughout the entire simulation domain. This data allows an accurate and robust approximation of the forward propagated source wave for all finite-difference approximation orders of the acoustic wave equation. The method reduces the amount of data storage required by an order of magnitude and overcomes the present challenge of requiring special large memory hardware while allowing for the implementation of 3D prestack reverse-time migration on off-the-shelf platforms.

### FIELD OF THE INVENTION

The present invention relates generally to a method for processing seismic data. More specifically, the present invention allows for a significant reduction in computer and bandwidth requirements in the reverse-time migration method for imaging subsurface geological structures.

### BACKGROUND OF THE INVENTION

Seismic exploration techniques are used widely in the oil and gas industry in the exploration for subterranean hydrocarbon deposits. One objective of such seismic exploration techniques is to construct accurate images of the geological structures of the earth's subsurface.

In seismic exploration, a source of seismic energy generates acoustic waves, typically in a “shot” from an explosive device. An array of seismic detectors, known as geophones, is commonly used to receive, or “gather” the acoustic waves that are reflected by the underground geological structures. When used on land this array of detectors is generally arranged in a two-dimensional grid. This method of collecting the seismic data required to construct the image is known as a “common-shot gather” configuration.

In such a common-shot gather configuration, the acoustic waves from the energy source propagate into the earth and are partially reflected and diffracted by the subsurface discontinuities in the earth, i.e., the interfaces between geological formations having different acoustic impedances. The reflected waves are recorded using the array of geophones at or near the surface of the earth, or on the overlying body of water in the case of ocean explorations. These seismic reflection signals are recorded in time and subsequently processed to obtain information about subsurface materials and formations.

A single shot generally results in gathered data that has a low signal to noise ratio and low coverage. Thus, it is typical to move the seismic source and do multiple shots, often many thousands of shots, in order to obtain a single image. The resulting signals will constructively interfere but must be processed in order to construct images of geological structures from this raw reflected data.

An important class of seismic processing technique used for constructing subsurface images from the raw reflected data is known as migration. Many migration techniques exist including Kirchhoff migration, frequency-wavenumber migration and one-way wave equation migration. These techniques are all known to those of skill in the art.

However, each of these techniques suffers from certain limitations. One limitation common to many techniques is that it is generally difficult to construct images of vertical or near-vertical surfaces (known as a “dip limitation”). Another limitation is that it can be difficult to image beneath regions with relatively high acoustic velocities, such as salt bodies. One particular type of migration that can overcome many such limitations is known as full wave prestack reverse-time depth migration, a robust and accurate seismic processing technique. The strengths of reverse time migration derive from the fact that it accounts for the full two-way acoustic wave equation (or its simpler constant-density variation, the scalar acoustic wave equation), which accurately describes the propagation of acoustic waves through the subsurface environment.

Full wave prestack reverse-time migration is a two-step process. First, the wavefield from the source (modeled from known source geometry) is continued downward to all depths of interest by modeling in a forward direction. Then, the recorded data samples are fed into the model at their respective positions (i.e. where the respective geophones are located) in reverse order, with the last time sample first, and the wave constructed from these data is continued downward by modeling backwards in time. In tandem with the back-propagation of the recorded data, at each depth and in backward increments of time, the downward-continued wavefields are convolved, or correlated, to calculate a scalar product. The resultant amplitude value is then attributed to the respective subsurface location.

It is expected that the strongest correlation amplitudes will be seen at subsurface locations where true reflections have occurred, i.e., at points where there is both a downward-propagating wavefront from the source and an upward propagating wavefront toward the receivers at the same time. From this determination of where reflections occur, it is possible to produce an image of the subsurface formations.

Two of the significant challenges facing the implementation of full wave prestack reverse-time depth migration include efficiently modeling the propagation of waves through subsurface media and allowing reverse order access to the source wave for correlation with the receiver data. The first of these challenges may be addressed by implementing the wave propagation calculations in a highly parallel environment.

The second challenge, of reverse order access to the source wave, could in theory be addressed by storing the values of the source wave for the entire volume of earth being considered at every time step. However, this “simple” solution requires an enormous amount of storage. It is typical to calculate values of the wavefield at points approximately 20 meters apart at time increments of 0.5 millisecond; with these increments, the source wave data for a full-scale reverse-time migration application across a typical volume having a surface area of hundreds or thousands of square kilometers and a depth of 5-10 kilometers or more would require terabytes of memory. Further, there is a significant amount of time and bandwidth associated with writing all of this data to memory and retrieving it when necessary for processing.

Various solutions have been proposed to address the problem of allowing reverse-time order access to the source wave. For example, one suggestion was that the source wave be stored across the volume but at a number of checkpoint time steps that are typically considerably farther apart than 0.5 millisecond, such that the wave at other time steps can be computed by repeating parts of the forward propagation as necessary. Symes, W. W., “Reverse Time Migration with Optimal Checkpointing,” Geophysics 72, pages 213-221, 2007. It will be evident that this approach requires additional computational steps to obtain the source wave during the back-propagation of the receiver wave.

Another suggested solution is to perform amplitude thresholding and save only wavefronts above a chosen threshold in the model volume. Chang, W. F., and McMechan, G. A., “3D Acoustic Prestack Reverse-Time Migration,” Geophysical Prospecting 38, pages 737-755, 1990. However, amplitude thresholding only allows for partial reconstruction of the source wave.

Many other variations of the reverse time migration technique have been proposed, usually with the aim of either improving image quality or reducing computation and/or memory requirements. For example, another proposal requires extrapolating the source and receiver wavefields using full wave finite-difference propagation equations and using one-way propagators to identify and separate waves propagating along different directions. Xie, X. B., and Wu, R. S., “A Depth Migration Method Based on the Full-Wave Reverse-Time Calculation and Local One-Way Propagation,” SEG New Orleans 2006 Annual Meeting, Extended Abstracts 2333-2337. This technique requires additional sophisticated post-processing to combine images from multi-directional wavefields.

Another approach divides large 3-D seismic volumes into subdomains from top to bottom. Downward propagation of fields in each subdomain is performed independently utilizing field values stored at the boundary of the previous subdomain. Mufti, I. R., et al., “Finite-Difference Depth Migration of Exploration-Scale 3-D Seismic Data,” Geophysics 61, 776-794. The limitation of this approach is that trace density decreases with increasing depth causing a progressive loss of wavefront curvature.

U.S. Pat. No. 4,964,103 describes a method of performing 3D ray-tracing from source and receiver positions to determine the location of subsurface reflection points. However, a significant disadvantage of ray-tracing is that rays to points within geometrical shadow zones may not exist.

U.S. Pat. No. 5,587,942 details an approach using inverse ray tracing of 3D time-dips to define a surface in a 3D volume for each line in a 2D seismic grid. Data from multiple lines in a 2D grid are migrated onto imaging surfaces in a 3D volume. The disadvantage of this approach is that complete imaging of all surfaces of a seismic volume requires multiple iterations of migration and thus significantly greater computing power.

U.S. Pat. No. 6,049,759 teaches using arrays of Green's function, used to solve inhomogeneous differential equations subject to boundary conditions, to determine theoretical travel times and resulting amplitudes of a wave front propagating from a point source on a surface. However, an efficient implementation of this technique is only achieved when a constant lateral velocity model is assumed for the seismic volume that is being migrated, which is generally not the case.

It is believed that another method has been proposed in which the source wave is reconstructed using data stored at every timestep, but at only a subset of the spatial points in the entire simulation volume. However, it is also believed that this method does not offer the same degree of reduction in memory and bandwidth requirements as the present invention.

Even with these solutions, the existing methods for performing 3D prestack reverse-time depth migration typically require excessively large memory space and/or computing power.

### SUMMARY OF THE INVENTION

The present invention provides a method for performing accurate 3D prestack reverse-time migration of seismic reflections that improves both computing memory and bandwidth requirements. The method allows for reconstruction of a close approximation of the source wave, in reverse-time order, with more manageable memory size and minimal additional computation than prior art techniques. In addition, the present invention allows for the implementation of 3D finite-difference approximation for wave propagation in seismic migration, which has the advantage of having no dip limitations when used with off-the-shelf hardware platforms.

The sequence of steps for a 3D prestack reverse-time migration typically includes specifying a velocity model in a finite simulation domain, forward modeling of the source wave, back-propagating the receiver wave and correlating the source and receiver waves at the end of every time step. Alternatively, the receiver wave can first be back-propagated and then the source wave can be propagated in a forward-time scheme with equivalent results.

In the method of the present invention a discretized model containing a “migration volume” and enclosed by boundaries with arbitrary boundary conditions is created. A source wave is forward propagated over the volume based upon the source data. The propagated source wave creates a wavefield, and values of the wavefield are saved at a single layer at the outer faces of the migration volume, just inside the boundaries, at the end of every time step of the simulation. Saving the source wave only at a single layer near the boundaries for every time step utilizes memory on the third power of the simulation dimensions (surface×time steps) as opposed to memory requirements on the fourth power of the simulation dimensions (volume×time steps) in the prior art case of saving the source wave in the simulation volume for every time step.

In the reverse-time migration step, receiver waves are back propagated into the volume based upon the receiver data. In parallel, the saved source wave is back-propagated into the simulation volume by using the saved values of the wavefield as time-varying boundary conditions, for the same time intervals as back propagation of the receiver data. The back-propagating source and receiver waves are correlated and summed at every time step to produce an image of the geological model.

The present invention allows for accurate source wave modeling that is not possible in ray-tracing or domain transformation methods, and may be used with all types of boundary conditions. The method is described for wave propagation utilizing finite-difference approximation of the scalar acoustic wave equation, but can be extended to the full acoustic wave equation or vector wave equations as well. The method may be applied in both isotropic and anisotropic media. The forward propagating source wave can further be compressed prior to storage to enhance the computer storage and memory bandwidth efficiency of the invention without significant loss of accuracy.

### BRIEF DESCRIPTION OF THE DRAWINGS

FIG. 1 illustrates an exemplary two-dimensional grid of geophone positions for a common-shot gather seismic data acquisition.

FIG. 2 is an illustration of an exemplary finite simulation domain of a seismic velocity model enclosed in absorbing boundaries.

FIG. 3A is an illustration of the points for which data is stored in a typical method according to the prior art.

FIG. 3B is an illustration of the points for which data is stored in the present invention.

FIG. 4. Is a flowchart of one embodiment of a sequence of a complete prestack reverse-time depth migration algorithm according to the present invention.

FIG. 5 is a flowchart of a more detailed embodiment of the forward modeling of the source wave step contained in FIG. 4.

FIG. 6 is a flowchart of one implementation of the back-propagation and imaging steps of the present invention contained in FIG. 4.

### DETAILED DESCRIPTION OF THE INVENTION

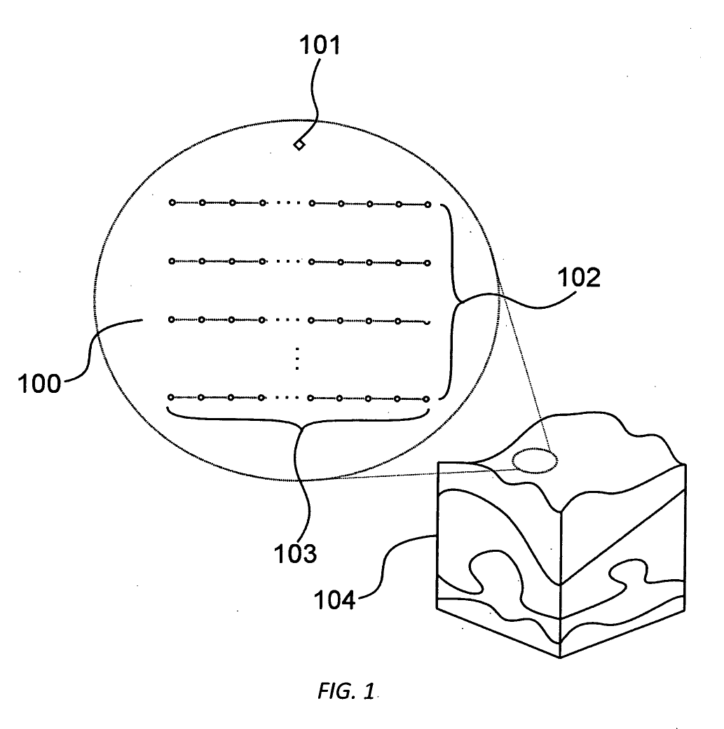

FIG. 1 shows an example of a typical two-dimensional sensor grid 100 that may be used to collect reflected acoustic waves for a single common-shot gather of seismic data. A source of seismic vibration 101 is excited while rows 102 of equally spaced geophones 103 record the reflections from three-dimensional subsurface geological formations 104. The source 101 is then typically moved along a line that is perpendicular to the rows 102 of the geophones and the process is repeated. The source 101 may also be moved in a direction parallel to rows 102. The acquired data are then processed and migrated for each single shot gather, and the results combined to create an image of the subsurface formations 104.

A typical survey might cover a surface area of 10,000 square kilometers, for example in a square 100 km by 100 km, and attempt to map subsurface structures to a depth of 5 to 10 kilometers or more. To perform such a survey on land, the sensor grid 100 might be 100 square kilometers, for example, 10 km by 10 km, with geophones 103 evenly spaced at about 20 meters apart. Many thousands of shots might be fired over time with the source 101 being moved approximately 100 to 200 meters between shots, with the sensor grid 100 being moved when the source 101 is too far removed from the geophones 103.

Collecting data at sea is more difficult. In this instance, a shot is typically fired from a boat which trails geophones 103 in a streamer that may be 5 to 10 km long, with the geophones 103 again spaced at about 20 meters apart. It has also become more common to have additional boats in the area towing other streamers of geophones; this allows data to be gathered over a two-dimensional area as on land, rather than only in a single dimension, and with greater offset from the shot.

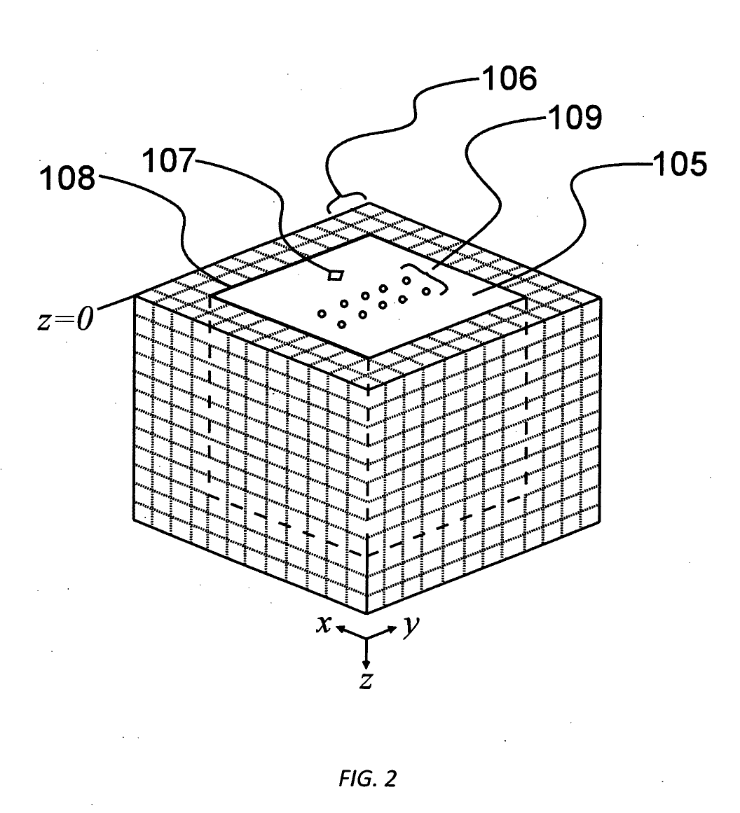

In FIG. 2, an exemplary finite simulation domain of a seismic migration volume enclosed in absorbing boundaries for performing migration of seismic data is shown. In a typical embodiment, the migration volume 105 is enclosed within specified layers of absorbing boundaries 106. Hard boundaries would create reflections in the model, so the absorbing boundaries 106 have a depth that may be varied as desired to reduce the impact of the reflections from boundaries 106 on the wavefields calculated in the migration volume 105. As illustrated, the migration volume 105 and boundaries 106 are rectilinear, as is conventional in the art. It is believed that the present invention performs optimally with arbitrary rectilinear boundaries, but different boundaries and boundary conditions may be specified in other embodiments.

Typically in reverse-time migration, the entire simulation volume 105 and boundaries 106 are discretized for the application of the finite-difference approximation to the scalar acoustic wave equation. The present invention is compatible with all finite-difference approximation orders. A model source 107, which corresponds to the physical source 101 of FIG. 1, is applied, typically on a grid point on the z=0 surface (corresponding to the surface of the earth or the ocean) of the migration volume 105 and the source wave is then propagated through the simulation model at increasing time steps pursuant to a velocity model.

Similarly, receiver data corresponding to the actual data received by geophones 103 of FIG. 1 are applied at the respective grid points 109, typically on the z=0 surface. The stored source waves are applied on the respective interfaces and back-propagation of the source and receiver waves are performed in parallel starting at the final recorded time with decreasing time until t=0.

In conventional reverse-time migration, the source wavefield is stored throughout the volume 105 for all relevant times. That is, the result of the source wave moving forward from the source is stored at each selected point in time, as above typically 0.5 millisecond apart, and each selected point in space, typically on the order of every 20 meters apart. The value of the wavefield at a point in space and time is a scalar representative of field strength, i.e., value of the pressure wave, and typically represented as a single-precision floating point number requiring four bytes of computer memory or other storage for one point in space at one point in time. It can readily be seen that storing all of the values of the wavefield resulting from the source wave over a volume of tens of thousands of cubic kilometers and the requisite time period takes a significant amount of memory.

In the present invention, the wavefield from the source wave is not saved throughout the volume 105, but is only saved at one layer of the interface 108 between the migration volume 105 and the absorbing boundaries 106 at the end of every time step. Specifically, the value of the wave field is saved at each point on the outer faces of the migration volume, just inside the boundary, again generally on the order of 20 meters apart. These values are again saved at time steps on the order of 0.5 millisecond as is conventional in the art.

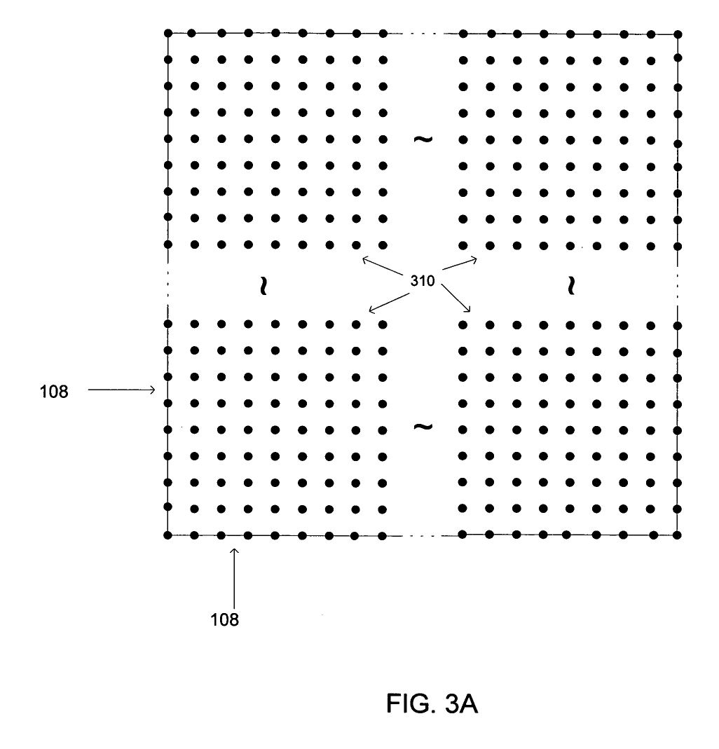

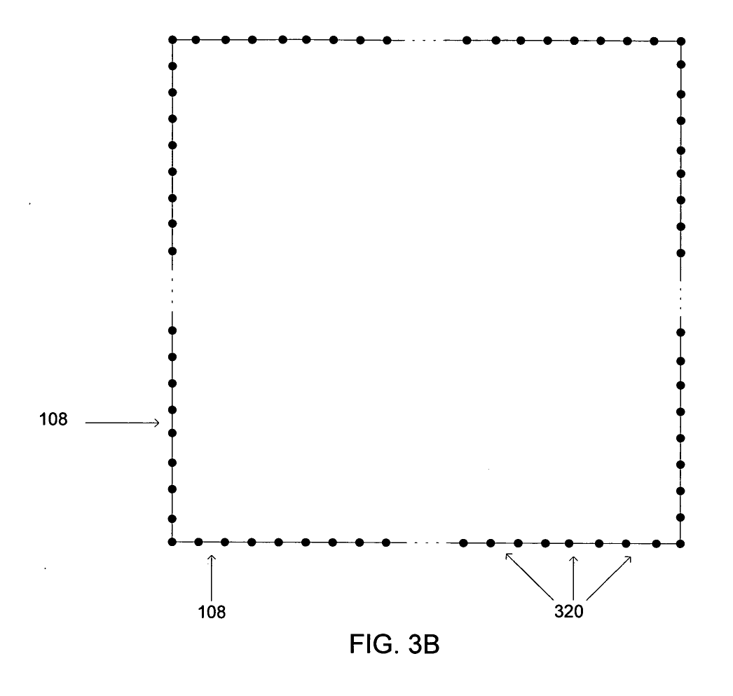

FIG. 3A is an illustration of the points for which data is stored in various embodiments of the prior art. FIG. 3A shows a rectilinear two dimensional cross-section of volume 105 of FIG. 2. Interfaces 108 between the migration volume 105 and boundaries 106 are located at the top, bottom and sides of volume 105. As above, each dimension of the migration volume may be tens of kilometers long. In various embodiments of the prior art, a wavefield value is typically stored for every one of these locations 310 for every time interval.

FIG. 3B is an illustration of the points for which data is stored in the present invention. As described herein, a single layer of data values for the wavefield are stored at locations 320 on the interfaces 108 between the migration volume 105 and the boundaries 106, typically on the order of 20 meters apart as in the prior art. No data values are stored for the remainder of the migration volume 105.

It should be apparent that by virtue of saving only points on the interfaces 108, the vast majority of points within the migration volume 105 are not saved. Accordingly, the improvement in memory requirements, compared to saving the source wave in the entire seismic volume, is at least one dimensional order of magnitude; i.e., O(N²T) as opposed to O(N³T), where N is representative of the number of grid points in one spatial dimension and T represents the number of time steps in the simulation. Alternatively, the receiver wave can be back-propagated in the first stage of the reverse time migration process and saved only at the boundaries, yielding a further similar memory efficiency with respect to storage of the values of the wavefield from the receiver wave.

One effect of the method of the present invention is that the wavefield from the source wave is not saved in its entirety, and, unlike some methods of the prior art, it may not be reconstructed in full detail. Rather than saving the value of the wavefield at the remaining points within the migration volume 105 at each point in time, and being able to fully reconstruct (or simply retrieve) the wavefield, a close approximation of the wavefield within the migration volume 105 may be calculated from this single layer of points. In addition, boundary calculations are typically done again on the backward migrating source wave.

While using stored values of the entire wavefield in migration volume 105 would result in a more accurate representation of the wavefield and thus in a more accurate result, it is believed that the results of correlating the approximated source wavefield with the backward propagating receiver wave differ only slightly from those obtained by using a fully stored source wavefield. The difference between the final migrated image produced by the current invention and that produced by an embodiment of the prior art in which the receiver wave is correlated with the exact source wave is not considered significant within the context of the art.

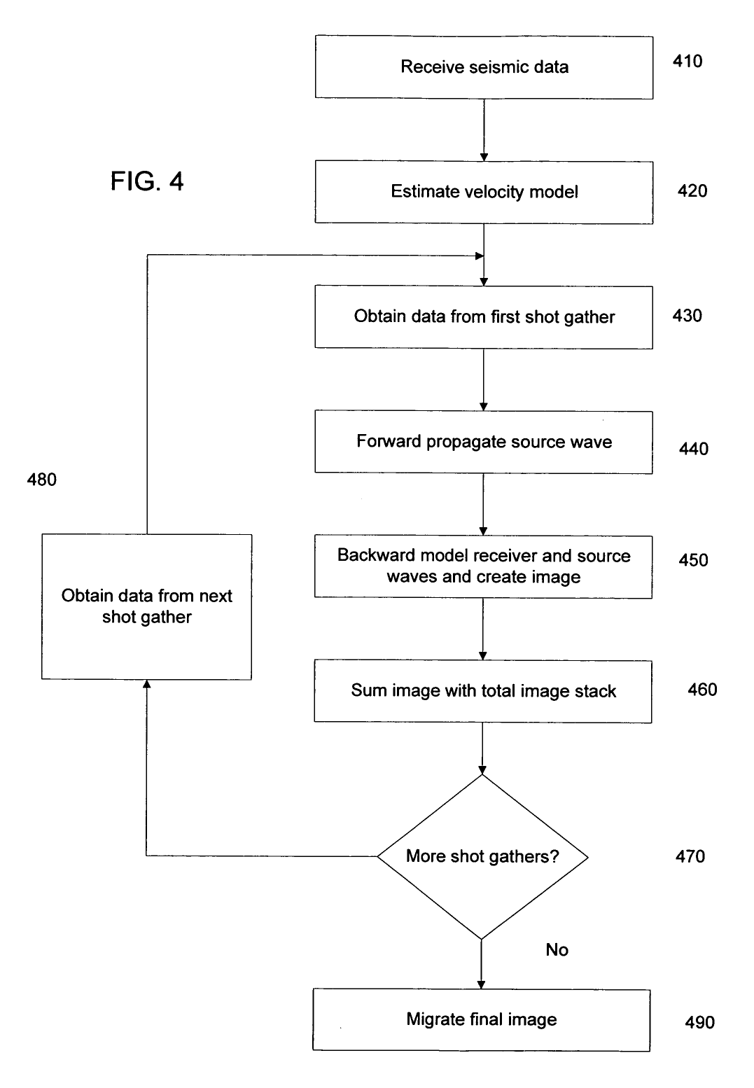

FIG. 4 is a flowchart that shows one complete cycle of operation of a method for prestack reverse-time migration of seismic data using the present invention. At step 410, a set of seismic data is received, such as that produced by an array 100 of geophones 103. At step 420, a previously-estimated 3D velocity model is discretized and padded with absorbing boundary layers. At step 430, data from a first shot gather is selected from the plurality of seismic data obtained in step 410, and the forward propagation of the source is calculated at step 440.

The backward modeling of receiver and source waves with image creation is performed at step 450. The image obtained from each shot gather is then summed with the total image stack from other shot gathers at step 460. At step 470, if there are additional shot gathers, the data from the next shot gather is obtained at step 480, and the process returns to step 440 to propagate the source wave of the next shot gather. This is repeated for all shot gathers. When all the shot gathers have been processed, a final total image is successfully migrated at step 490.

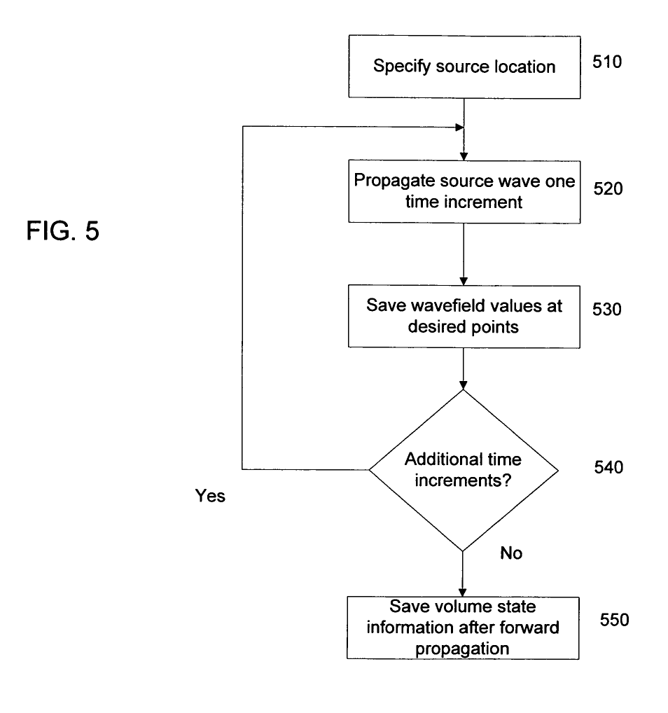

FIG. 5 is a flowchart illustrating the steps involved in the forward propagation of the source wave of step 440 of FIG. 4 in more detail. The location of the source on the discretized model is specified to correspond to the location of the physical source and the time signature is specified at step 510. It is not necessary to specify a precise waveform for the source, although it may be desirable that the frequency content be configurable and band-limited.

At step 520 the source wave is modeled from the source data and is propagated forward for one time increment using the finite-difference approximation of the scalar acoustic wave equation. At step 530 the values of the wavefield at the interfaces between the migration volume and the absorbing boundaries are saved at the end of the time increment.

At step 540, if there are additional time increments to be processed, the process returns to step 520, and steps 520 and 530, the forward propagation of the source wave and saving of wavefield values at the boundaries, respectively, are repeated at successive time intervals until there is no further trace data.

Alternatively, the user may specify that the values of the wavefield at the interfaces be saved only at certain times. For example, the earliest time at which the source wave will arrive at a boundary may be estimated and no data saved before this time is reached to reduce the number of time steps at which the wave field is saved. Compression of the source data may also be performed prior to saving the data.

Once all time increments have been processed, at step 550 the state of the 3D seismic volume after the completion of the forward propagation of the source wave forms the initial state of the simulation domain for back-propagation.

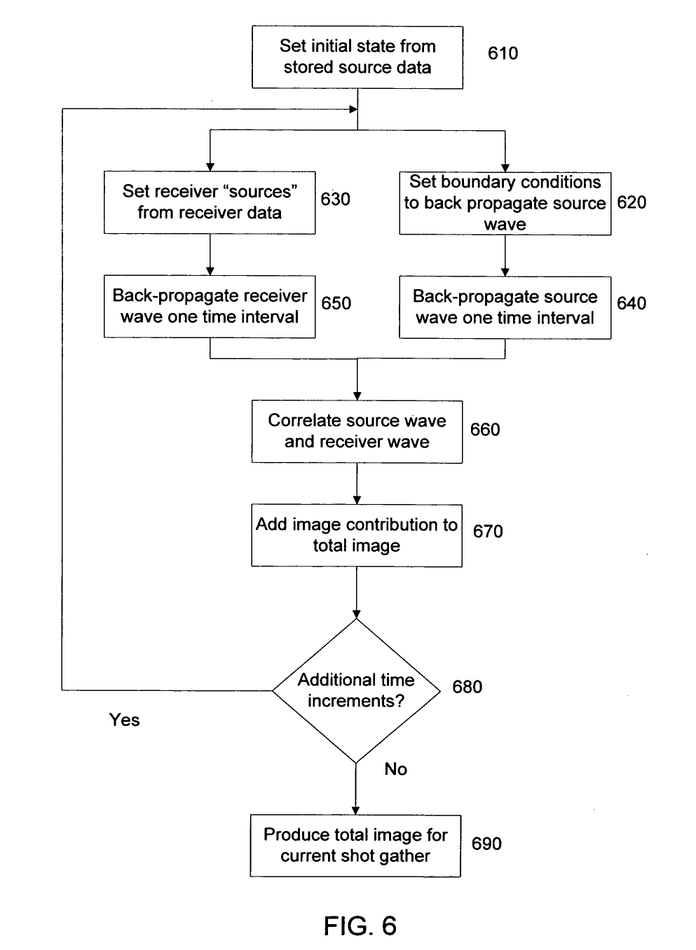

FIG. 6 is a flowchart of the more detailed steps involved in the backward modeling of receiver and source waves with image creation for each shot gather, step 450 in FIG. 4. In back-propagation, the final state of the source wave within the seismic volume after the forward propagation forms the initial state for the back-propagation of the source wave (step 610). At step 620, the stored source wave data from step 530 in FIG. 5 are initialized on the interface grid points between the migration volume and absorbing boundaries, and at step 620 these stored data are used as boundary conditions to back-propagate the source wave. At step 630, data collected by the receivers 109 in FIG. 2 are also specified as “sources,” typically on the top boundary of the simulation domain.

Starting from the final time step of the trace data, and in reverse time towards the shot at t=0, the source and receiver waves are back-propagated in parallel through the simulation domain one time interval at a time, in steps 640 and 650 respectively. At the end of every time step, the waves are correlated at every grid point in the migration volume at step 660, and the correlation results are then summed to the total image in step 670 to update the cumulative image at the end of every time step.

As part of step 640, as above the stored boundary values are used to calculate an approximation of the backward migrating source wave. However, the time cost of this additional processing is believed to be far less than the time cost of retrieving the additional order of magnitude of data needed to store the entire wavefield.

At step 680, if there are further time increments to be processed, the process returns and repeats the back-propagation and image creation of steps 620 to 670 for each time interval until the time step of the initial excitation of the source wave, usually t=0. A total 3D image of the current shot gather is obtained at the end of the backward modeling at step 690.

As discussed with respect to FIG. 4 above, the image obtained from each shot gather is then summed with the total image stack from other shot gathers at step 460 and the process is repeated for all shot gathers until a final total image is successfully migrated at step 490.

As above, it has been a long standing problem in 3D prestack reverse-time depth migration that large amounts of data, as much as terabytes, must be stored to save the source wavefield in its entirety in order to have the data available for the reverse migration and correlation with the receiver wave. In addition, there is a significant resulting time latency from moving the data onto and off of the respective computer processors for computation. By saving the source wavefield only at the boundaries instead of throughout the entire computation domain, both of these problems are significantly reduced. Further, the state of the seismic volume that is saved at the end of the forward propagation of the source wave need not be written out to memory. Back-propagation can be performed directly on the final state of the seismic computation volume.

The invention has been explained above with reference to several embodiments. Other embodiments will be apparent to those skilled in the art in light of this disclosure. The present invention may readily be implemented using configurations other than those described in the embodiments above, or in conjunction with systems other than the embodiments described above.

For example, while the method is described for wave propagation utilizing finite-difference approximation of the scalar acoustic wave equation, it may be extended to the full acoustic wave equation or to vector wave equations and may be applied in both isotropic and anisotropic media. Additional compression of wavefield data prior to storage may also be used to enhance the computer storage and memory bandwidth efficiency of the invention without significant loss of accuracy.

It should also be appreciated that the present invention can be implemented in numerous ways, including as a process, an apparatus, a system, a computer readable storage medium such as a hard disk drive, floppy disk, optical disc such as a compact disc (CD) or digital versatile disc (DVD), flash memory, etc., on which program instructions for performing the methods described herein are stored, or a computer network wherein the program instructions are sent over optical or electronic communication links. It should be noted that the order of the steps of the methods described herein may be altered within the scope of the invention.

These and other variations upon the embodiments are intended to be covered by the present invention, which is limited only by the appended claims.

What is claimed is:

1. A method for computing prestack reverse-time migration of recorded seismic data, comprising:
creating a discretized model containing a volume enclosed by boundaries with arbitrary boundary conditions;
forward propagating a source wave over the volume based upon the source data;
saving values of the wavefield created by the source wave at an interface between the boundaries and the migration volume;
back propagating receiver waves based upon the receiver data;
back propagating the source wave by using the saved values of the wavefield as time-varying boundary conditions, for the same time intervals as the back propagation of the receiver data; and
correlating the back propagated source wave and back propagated receiver data.

2. The method of claim 1 wherein forward propagating the source wave further comprises calculating a numerical finite-difference approximation to the scalar acoustic wave equation.

3. The method of claim 1 wherein forward propagating the source wave further comprises calculating a numerical finite-difference approximation to the full acoustic wave equation.

4. The method of claim 1 wherein forward propagating the source wave further comprises calculating a numerical finite-difference approximation to vector wave equations.

5. The method of claim 1 wherein the model volume is considered isotropic with respect to wave propagation.

6. The method of claim 1 wherein the model volume is considered anisotropic with respect to wave propagation.

7. The method of claim 1 wherein the model volume is considered to comprise a combination of isotropic and anisotropic regions with respect to wave propagation.

8. The method of claim 1, wherein saving values of the wavefield further comprises saving values of the source wave at intervals from the initial excitation time of the source wave until the final time step of the finite-difference computation.

9. The method of claim 1, wherein saving values of the wave field further comprises saving values of the source wave at intervals from the earliest estimated arrival time of the source wave on the boundary until the final time step of the finite-difference computation.

10. The method of claim 1, wherein saving values of the wavefield further comprises compressing the data prior to saving values of the wavefield, and back propagating the source wave further comprises decompressing the saved values of the wavefield.

11. The method of claim 1, wherein the back propagating of the source wave and receiver waves are performed in parallel.

12. The method of claim 1, in which the recorded seismic data represents multiple independent shot gathers of seismic data.

13. The method of claim 1, in which the recorded seismic data represents multiple simultaneous shot gathers of seismic data.

14. A method for computing prestack reverse-time migration of recorded seismic data, comprising:
creating a discretized model containing a volume enclosed by boundaries with arbitrary boundary conditions;
back propagating the receiver wave over the volume based upon the receiver data;
saving values of the wavefield created by the receiver wave at the boundaries of the migration volume;
forward propagating a source wave based upon the source data;
forward propagating the receiver wave by using the saved values of the wavefield as time-varying boundary conditions, for the same time intervals as the forward propagation of the source data; and
correlating the forward propagated source wave and forward propagated receiver data.

15. The method of claim 14 wherein back propagating the receiver wave further comprises calculating a numerical finite-difference approximation to the scalar acoustic wave equation.

16. The method of claim 14 wherein back propagating the receiver wave further comprises calculating a numerical finite-difference approximation to the full acoustic wave equation.

17. The method of claim 14 wherein back propagating the receiver wave further comprises calculating a numerical finite-difference approximation to vector wave equations.

18. The method of claim 14 wherein the model volume is considered isotropic with respect to wave propagation.

19. The method of claim 14 wherein the model volume is considered anisotropic with respect to wave propagation.

20. The method of claim 14 wherein the model volume is considered to comprise a combination of isotropic and anisotropic regions with respect to wave propagation.

21. The method of claim 14, wherein saving values of the wavefield further comprises saving values of the receiver wave at intervals from the final time step of the receiver wave until the initial excitation time of the finite-difference computation.

22. The method of claim 14, wherein saving values of the wavefield further comprises saving values of the receiver wave at intervals from the earliest estimated arrival time of the receiver wave on the boundary until the initial excitation time of the finite-difference computation.

23. The method of claim 14, wherein saving values of the wavefield further comprises compressing the data prior to saving values of the wavefield, and forward propagating the receiver wave further comprises decompressing the saved values of the wavefield.

24. The method of claim 14, wherein the forward propagating of the source wave and receiver waves are performed in parallel.

25. The method of claim 14, in which the recorded seismic data represents multiple independent shot gathers of seismic data.

26. The method of claim 14, in which the recorded seismic data represents multiple simultaneous shot gathers of seismic data.

27. A computer-readable storage medium having embodied thereon a program, the program being executable by one or more processors to perform a method for computing prestack reverse-time migration of recorded seismic data, the method comprising:
creating a discretized model containing a volume enclosed by boundaries with arbitrary boundary conditions;
forward propagating a source wave over the volume based upon the source data;
saving values of the wavefield created by the source wave at an interface between the boundaries and the migration volume;
back propagating receiver waves based upon the receiver data;
back propagating the source wave by using the saved values of the wavefield as time-varying boundary conditions, for the same time intervals as the back propagation of the receiver data; and
correlating the back propagated source wave and back propagated receiver data.
